(19) United States
(12) Patent Application Publication
(10) Pub. No.: US 2026/0350740 A1
(43) Pub. Date: Nov. 5, 2026

(54) ELECTRONIC DEVICE AND IMAGE PROCESSING METHOD FOR VIDEO INTERPOLATION

(71) Applicant: NOVATEK Microelectronics Corp., Hsinchu (TW)

(72) Inventors: Hsiao-En CHANG, Hsinchu (TW); Jen-Huan HU, Taipei City (TW); Tzu-Ting FANG, Hsinchu City (TW)

(21) Appl. No.: 19/195,718

(22) Filed: Apr. 30, 2025

(51) Int. Cl. G06T 3/4007; G06T 7/223; G06T 7/246

(52) U.S. Cl. CPC G06T 3/4007; G06T 7/223; G06T 7/248; G06T 2207/20081; G06T 2207/20221

(57) ABSTRACT

An electronic device includes a video source and a processor. The video source is configured to provide a first video including a previous frame and a current frame. The processor is configured to perform a block-matching-based motion estimation, between the previous frame and the current frame, for generating some block-matching-based results. The processor is configured to perform an AI-based motion estimation, between the previous frame and the current frame, for generating some AI-based results. The processor is configured to generate a first interpolated frame based on the block-matching-based results, and to generate a second interpolated frame based on the AI-based results. The processor is configured to calculate AI weight map based on the block-matching-based results. The processor is configured to merge the first interpolated frame and the second interpolated frame according to the AI weight map, for generating an output interpolated frame.

### BACKGROUND

### Field of Invention

The disclosure relates to an electronic device and an image processing method. More particularly, the disclosure relates to an image processing method capable of generating an interpolated frame based on integrations of a block-matching-based manner and an AI-based manner.

### Description of Related Art

Motion estimation and motion compensation (MEMC) is a technology used for frame interpolation, which allows a series of image frames to be displayed with a higher frame rate. For example, if a 30 Hz source video such as a film is required to be displayed in 60 Hz, an interpolated frame should be added between every two adjacent input frames of the source video, so as to double the frame rate. The images of the interpolated frame may be predicted by using motion vectors (MVs) between a current input frame and a previous input frame, so as to display the output video smoothly.

Since the interpolated frame is constructed by using originally inexistent images generated based on the motion vectors, the accuracy of the motion vectors is essential during the MEMC operations. If an interpolated image is generated based on inaccurate motion vectors, a halo or a data-broken region may be generated in the interpolated image, and the halo or the data-broken region may appear around a boundary of a moving object. Thus, people in the industry are making their efforts to improve the accuracy of motion vector prediction, especially for those blocks at the boundary of foreground objects.

### SUMMARY

An embodiment of the disclosure provides an electronic device, which includes a video source and a processor. The video source is configured to provide a first video including a previous frame and a current frame. The processor is coupled to the video source. The processor is configured to perform a block-matching-based motion estimation, between the previous frame and the current frame, for generating a first motion vector, a first occlusion parameter and a sum of absolute differences (SAD) parameter. The processor is further configured to perform an AI-based motion estimation, between the previous frame and the current frame, for generating a second motion vector and a second occlusion parameter. The processor is further configured to perform a motion compensation according to the first motion vector, the first occlusion parameter, the previous frame and the current frame, for generating a first interpolated frame. The processor is further configured to perform another motion compensation according to the second motion vector, the second occlusion parameter, the previous frame and the current frame, for generating a second interpolated frame. The processor is further configured to calculate an AI weight map according to the first motion vector and the SAD parameter. The processor is further configured to merge the first interpolated frame and the second interpolated frame according to the AI weight map, for generating an output interpolated frame.

Another embodiment of the disclosure provides an image processing method, which include following steps: receiving a first video comprising a previous frame and a current frame; performing a block-matching-based motion estimation, between the previous frame and the current frame, for generating a first motion vector, a first occlusion parameter, and a sum of absolute differences (SAD) parameter; performing an AI-based motion estimation, between the previous frame and the current frame, for generating a second motion vector and a second occlusion parameter; performing a motion compensation according to the first motion vector, the first occlusion parameter, the previous frame and the current frame, for generating a first interpolated frame; performing the motion compensation according to the second motion vector, the second occlusion parameter, the previous frame and the current frame, for generating a second interpolated frame; calculating an AI weight map according to the first motion vector and the SAD parameter; and, merging the first interpolated frame and the second interpolated frame according to the AI weight map, for generating an output interpolated frame.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an electronic device according to some embodiments of the disclosure.

FIG. 2 is a schematic diagram illustrating functional blocks in the processor for generating the output interpolated frame between the adjacent input frames according to some embodiments of the disclosure.

FIG. 3A is a schematic diagram illustrating an interpolated pixel of a first interpolated frame generated according to the previous frame and the current frame in some embodiments.

FIG. 3B is a schematic diagram illustrating interpolated pixels of the first interpolated frame with reference to the first occlusion parameter in some embodiments.

FIG. 4 is a schematic diagram illustrating a training procedure of the AI motion estimation model.

FIG. 5 is a schematic diagram illustrating an interpolated pixel of the second interpolated frame generated according to the previous frame and the current frame in some embodiments.

FIG. 6 is a schematic diagram illustrating a reference window around a target block according to some embodiments.

FIG. 7 is a schematic diagram illustrating how the AI weight calculator calculates the AI weight for the target block according to some embodiments.

FIG. 8 is a schematic diagram illustrating an original frame in the first video in some embodiments.

FIG. 9 is a schematic diagram illustrating the AI weight map calculated based on the original frame in the first video shown in FIG. 8.

FIG. 10 is a flowchart diagram illustrating the image processing method in some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

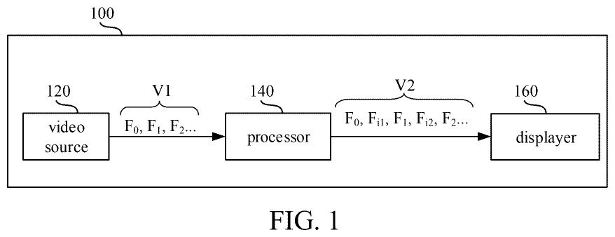

Reference is made to FIG. 1, which is a schematic diagram illustrating an electronic device 100 according to some embodiments of the disclosure. As shown in FIG. 1, the electronic device 100 includes a video source 120, a processor 140 and a displayer 160. For example, the electronic device 100 can be a television, a smart television, a mobile phone, a smartphone or a video projector.

The video source 120 can be a data storage unit (e.g., flash memory or hard disk) or an interface connector (e.g., USB connector, HDMI connector) for storing/providing a first video V1 with a first frame rate (e.g., 30 Hz). The displayer 160 can be a LCD display panel, a LED display panel, a plasma display panel or a projecting module, which is capable of displaying a second video V2 with a second frame rate (e.g., 60 Hz) higher than the first frame rate.

As shown in FIG. 1, the first video V1 includes sequential frames F₀, F₁, F₂ and so on. The processor 140 is coupled between the video source 120 and the displayer 160. The processor 140 is able to generate output interpolated frames between adjacent frames in the first video V1, so as to form the second video V2. The processor 140 may include a central processing unit (CPU), a graphics processing unit (GPU), a tensor processing unit (TPU), a frame rate conversion (FRC) integrated circuit, or an application-specific integrated circuit (ASIC).

As shown in FIG. 1, the processor 140 is able to generate an output interpolated frame Fᵢ₁ based on a previous frame (e.g., the frame F₀) and a current frame (e.g., the frame F₁) among the first video V1, and the output interpolated frame Fᵢ₁ can be inserted between the frames F₀ and F₁ for forming the second video V2.

Similarly, the processor 140 is able to generate another output interpolated frame Fᵢ₂ based on a previous frame (e.g., the frame F₁) and a current frame (e.g., the frame F₂) among the first video V1, and the output interpolated frame Fᵢ₂ can be inserted between the frames F₁ and F₂ for forming the second video V2. In this case, the second video V2 after adding the output interpolated frames Fᵢ₁ and Fᵢ₂ will have the higher frame rate.

Similarly, subsequent frames in the first video V1 can be processed by the processor 140 in the same manner for generating other interpolated frames and forming the second video V2. For brevity, details about generating the output interpolated frame Fᵢ₁ by the processor 140 between the adjacent frames F₀ and F₁ are discussed in following embodiments.

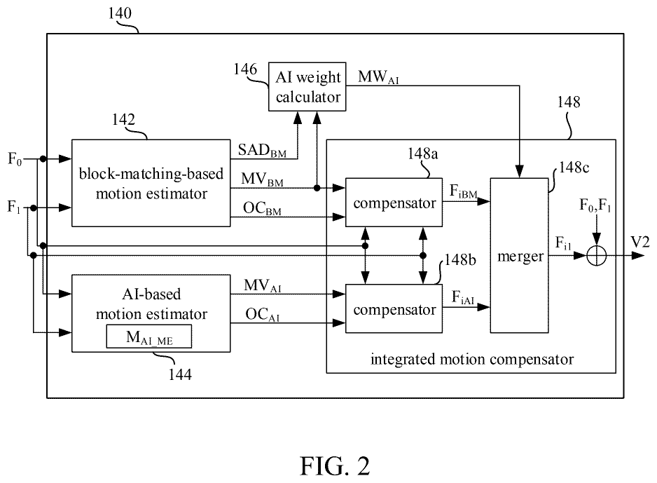

Reference is further made to FIG. 2, which is a schematic diagram illustrating functional blocks in the processor 140 for generating the output interpolated frame Fᵢ₁ between the frames F₀ and F₁ according to some embodiments of the disclosure.

In some embodiments, the processor 140 is configured to perform motion estimation and motion compensation (MEMC) to generate the appropriate interpolated frame Fᵢ₁ based on the input frames F₀ and F₁. MEMC helps to achieve smoother motion, which is useful in TVs (for motion smoothing), video editing, slow-motion effects, and upscaling.

In general, MEMC includes two stages which are the motion estimation (ME) and the motion compensation (MC). The motion estimation (ME) is the process of analyzing two consecutive video frames to estimate the movement of objects or regions between them.

In some embodiments, the processor 140 is configured to perform a block-matching-based motion estimation and an AI-based motion estimation, and integrate the results from two different motion estimations. As shown in FIG. 2, the processor 140 is configured to execute a block-matching-based motion estimator 142, an AI-based motion estimator 144, an AI weight calculator 146 and an integrated motion compensator 148.

In some embodiments, the block-matching-based motion estimator 142, the AI-based motion estimator 144, the AI weight calculator 146 and the integrated motion compensator 148 can be implemented by computer-executive instructions executed by the processor 140, or implemented by an application-specific integrated circuit (ASIC) or a field-programmable gate array (FPGA) circuit.

The block-matching-based motion estimator 142 is configured to perform a block-matching-based motion estimation, between the previous frame F₀ and the current frame F₁, for generating a first motion vector MV_{BM}, a first occlusion parameter OC_{BM} and a sum of absolute differences (SAD) parameter SAD_{BM}.

The block-matching-based motion estimation is a way to perform the motion estimation includes dividing the frames into blocks, finding where each block moved between frames and generating motion vectors describing movements of these blocks. The block offsets between frames are motion vectors. It is also regarded as the block-matching-based motion estimation. The block-matching-based motion estimation is relative simple to implement, and it is able to generate the motion vectors at a high speed. The block-matching-based motion estimation has some issues. For example, the block-matching-based motion estimation assumes all pixels in a block move the same, and the block-matching-based motion estimation is not accurate at estimating motion at edges or deforming objects.

The first motion vector MV_{BM} is configured to describe a movement of a target block between the previous frame F₀ and the current frame F₁. The sum of absolute differences parameter SAD_{BM} is a parameter used in block matching algorithm. The sum of absolute differences parameter SAD_{BM} is used to quantify the similarity between two image blocks. It helps in finding the best matching block from one frame to another, facilitating motion estimation. For each pixel in the target block, compute the absolute difference between it and the corresponding pixel in the block being compared. In video frame interpolation using MEMC, the first occlusion parameter OC_{BM} is utilized to deal with foreground-background overlapping regions between frames.

As shown in FIG. 2, a motion compensator 148a of the integrated motion compensator 148 is able to perform motion compensation according to the first motion vector MV_{BM}, the first occlusion parameter OC_{BM}, the previous frame F₀ and the current frame F₁, for generating a first interpolated frame F_{iBM}.

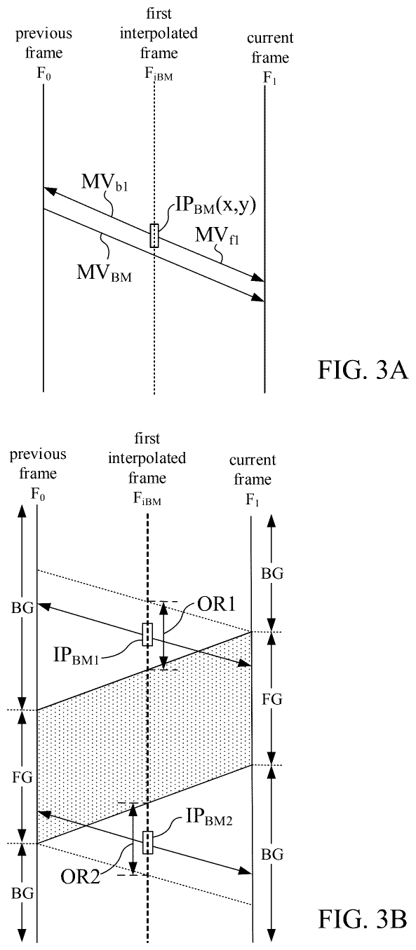

Reference is further made to FIG. 3A, which is a schematic diagram illustrating an interpolated pixel IP_{BM}(x,y) of the first interpolated frame F_{iBM} generated according to the previous frame F₀ and the current frame F₁ in some embodiments.

As shown in FIG. 3A, a backward motion vector MV_{b1} and a forward motion vector MV_{f1} can be derived from the first motion vector MV_{BM}. The backward motion vector MV_{b1} indicate a movement from the interpolated pixel IP_{BM}(x,y) of the first interpolated frame F_{iBM} to a corresponding pixel of the previous frame F₀. The forward motion vector MV_{f1} indicate a movement from the interpolated pixel IP_{BM}(x,y) of the first interpolated frame F_{iBM} to a corresponding pixel of the current frame F₁.

In some embodiments, the interpolated pixel IP_{BM}(x,y) of the first interpolated frame F_{iBM} is calculated by:

IP_{BM}(x,y)=F₀(x+MV_{b1x},y+MV_{b1y})*OC_{BM}+F₁(x+MV_{f1x},y+MV_{f1y})*(1−OC_{BM}).

In aforesaid equation, “MV_{b1x}” represents the x-axis component of the backward motion vector MV_{b1}; “MV_{b1y}” represents the y-axis component of the backward motion vector MV_{b1}; “MV_{f1x}” represents the x-axis component of the forward motion vector MV_{f1}; “MV_{f1y}” represents the y-axis component of the forward motion vector MV_{f1}. The first occlusion parameter OC_{BM} is a variable between 0~1 for resolving the foreground-background overlapping issue.

Reference is further made to FIG. 3B, which is a schematic diagram illustrating interpolated pixels IP_{BM1} and IP_{BM2} of the first interpolated frame F_{iBM} with reference to the first occlusion parameter OC_{BM} in some embodiments.

As shown in FIG. 3B, because the foreground object FG and the background BG may move in different direction between the previous frame F₀ and the current frame F₁, there will be foreground-background overlapping regions OR1 and OR2 on the first interpolated frame F_{iBM}. As the embodiment illustrated in FIG. 3B, the foreground object FG is moved from a lower position in the previous frame F₀ to a higher position in the current frame F₁. Correspondingly, a distribution of the background BG also changes between the previous frame F₀ and the current frame F₁.

For the interpolated pixel IP_{BM1} in the foreground-background overlapping region OR1, the first occlusion parameter OC_{BM} will be set at “1”, such that the interpolated pixel IP_{BM1} will refer to the corresponding pixel in the previous frame F₀.

On the other hand, for the interpolated pixel IP_{BM2} in the foreground-background overlapping region OR2, the first occlusion parameter OC_{BM} will be set at “0”, such that the interpolated pixel IP_{BM2} will refer to the corresponding pixel in the current frame F₁.

For other interpolated pixels outside the foreground-background overlapping regions OR1 and OR2, the first occlusion parameter OC_{BM} can be set at “0.5”, such that the interpolated pixels will refer to both of the previous frame F₀ and the current frame F₁.

The AI-based motion estimator 144 is configured to perform an AI-based motion estimation, between the previous frame F₀ and the current frame F₁, for generating a second motion vector MV_{AI} and a second occlusion parameter OC_{AI}.

The AI-based motion estimation is another way to perform the motion estimation is realized by an AI image analyzing model, which learns to predict per-pixel motion (optical flow) using deep neural networks. It is also regarded as the AI-based motion estimation. In some embodiments, the AI-based motion estimation can be implemented by a neural network model (e.g., PWC-Net, RAFT, or FlowNet) that takes two frames as input. The AI-based motion estimation is able to outputs a dense optical flow map, in which every pixel has its own motion vector. The AI-based motion estimation is able to track subtle or non-linear motion, and it can handle the overlapping objects better. The AI-based motion estimation has some issues. For example, the AI-based motion estimation requires training, large datasets, and more computation. Besides, the AI-based motion estimation generates the motion vectors at a relative slower speed.

The second motion vector MV_{AI} is configured to describe a movement of a target pixel between the previous frame F₀ and the current frame F₁. In video frame interpolation using MEMC, the second occlusion parameter OC_{AI} is utilized to deal with foreground-background overlapping regions between frames.

As shown in FIG. 2, in some embodiments, the processor 140 executes an AI motion estimation model M_{AI_ME} for performing the AI-based motion estimation. The AI motion estimation model M_{AI_ME} is required to be trained in advance for generating the second motion vector MV_{AI} and the second occlusion parameter OC_{AI} accurately. In practical applications, it is hard to find labelled training data about the second motion vector MV_{AI} and the second occlusion parameter OC_{AI}.

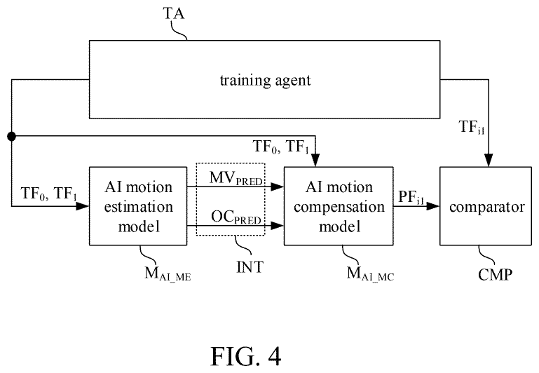

Reference is further made to FIG. 4, which is a schematic diagram illustrating a training procedure of the AI motion estimation model M_{AI_ME}. As shown in FIG. 4, during the training procedure, the AI motion estimation model M_{AI_ME} is trained together with an AI motion compensation model M_{AI_MC} in an end-to-end manner according to training input frames TF₀ and TF₁ and a training ground interpolated frame TFᵢ₁.

As shown in FIG. 4, the AI motion estimation model M_{AI_ME} is configured to generate an intermediate output data INT according to the training input frames TF₀ and TF₁. The intermediate output data INT includes a prediction motion vector MV_{PRED} and a prediction occlusion parameter OC_{PRED} corresponding to the training input frames TF₀ and TF₁.

The AI motion compensation model M_{AI_MC} is configured to generate a prediction interpolated frame PFᵢ₁ according to the intermediate output data INT and also the training input frames TF₀ and TF₁. The comparator CMP is configured to compare the prediction interpolated frame PFᵢ₁ with the training ground interpolated frame TFᵢ₁. According to the comparison result, the comparator CMP is configured to perform a backpropagation for optimizing the AI motion estimation model M_{AI_ME} and the AI motion compensation model M_{AI_MC}.

As shown in FIG. 2, another motion compensator 148b of the integrated motion compensator 148 is able to perform motion compensation according to the second motion vector MV_{AI}, the second occlusion parameter OC_{AI}, the previous frame F₀ and the current frame F₁, for generating a second interpolated frame F_{iAI}.

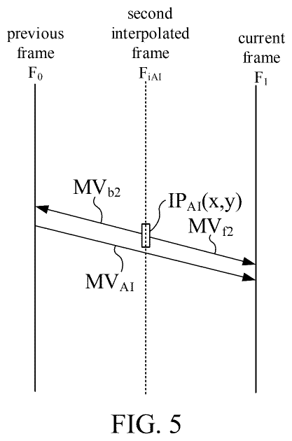

Reference is further made to FIG. 5, which is a schematic diagram illustrating an interpolated pixel IP_{AI}(x,y) of the second interpolated frame F_{iAI} generated according to the previous frame F₀ and the current frame F₁ in some embodiments.

As shown in FIG. 5, a backward motion vector MV_{b2} and a forward motion vector MV_{f2} can be derived from the second motion vector MV_{AI}. The backward motion vector MV_{b2} indicate a movement from the interpolated pixel IP_{AI}(x,y) of the second interpolated frame F_{iAI} to a corresponding pixel of the previous frame F₀. The forward motion vector MV_{f2} indicate a movement from the interpolated pixel IP_{AI}(x,y) of the second interpolated frame F_{iAI} to a corresponding pixel of the current frame F₁.

In some embodiments, the interpolated pixel IP_{AI}(x,y) of the second interpolated frame F_{iAI} is calculated by:

IP_{AI}(x,y)=F₀(x+MV_{b2x},y+MV_{b2y})*OC_{AI}+F₁(x+MV_{f2x},y+MV_{f2y})*(1−OC_{AI}).

In aforesaid equation, “MV_{b2x}” represents the x-axis component of the backward motion vector MV_{b2}; “MV_{b2y}” represents the y-axis component of the backward motion vector MV_{b2}; “MV_{f2x}” represents the x-axis component of the forward motion vector MV_{f2}; “MV_{f2y}” represents the y-axis component of the forward motion vector MV_{f2}. The second occlusion parameter OC_{AI} is a variable between 0~1 for resolving the foreground-background overlapping issue.

The second occlusion parameter OC_{AI} is a variable between 0~1 for resolving the foreground-background overlapping issue. Details about how the second occlusion parameter OC_{AI} is used to resolve the foreground-background overlapping issue are similar to aforesaid embodiments about the first occlusion parameter OC_{BM} shown in FIG. 3B, and not repeated here again.

As shown in FIG. 2, the AI weight calculator 146 is configured to calculate an AI weight map MW_{AI} according to the first motion vector MV_{BM} and the SAD parameter SAD_{BM} generated by the block-matching-based motion estimator 142.

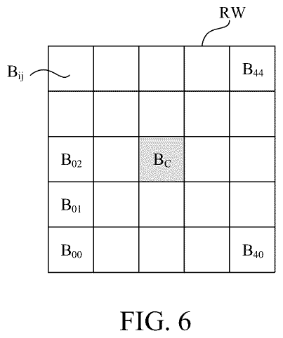

The AI weight map MW_{AI} includes multiple blocks. At first, the AI weight calculator 146 determines a reference window around a target block. Reference is further made to FIG. 6, which is a schematic diagram illustrating a reference window RW around a target block B_{C} according to some embodiments. The AI weight calculator 146 is configured to calculate an AI weight W_{AI} for the target block B_{C} according to the first motion vector MV_{BM} and the SAD parameter SAD_{BM} on adjacent blocks Bᵢⱼ in the reference window RW. In this embodiments, the adjacent blocks Bᵢⱼ on +2 to −2 rows and +2 to −2 columns around the target block B_{C} are selected into the reference window RW, but the disclosure is not limited thereto.

As shown in FIG. 6, the adjacent blocks Bᵢⱼ includes the block B₀₀, B₀₁, B_{02 . . .} B_{40 . . .} B₄₄. In this case, for adjacent blocks Bᵢⱼ, i=0~4 and j=0~4.

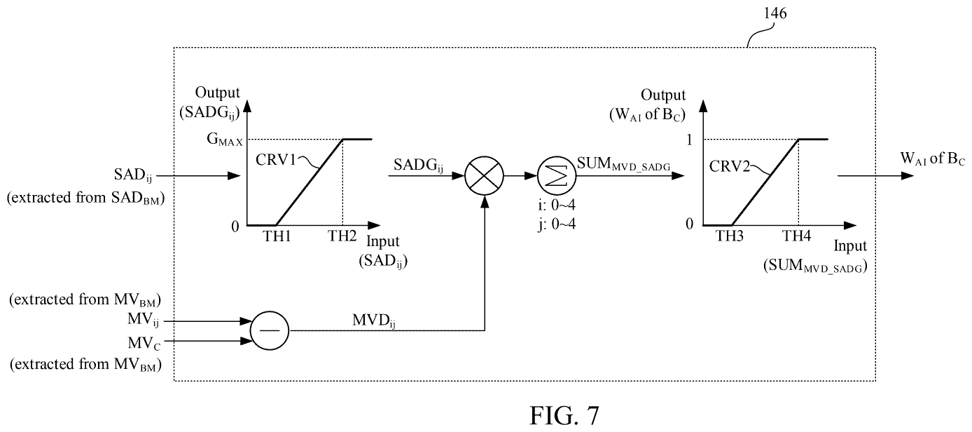

Reference is further made to FIG. 7, which is a schematic diagram illustrating how the AI weight calculator 146 calculates the AI weight W_{AI} for the target block B_{C} according to some embodiments.

SAD parameters SADij of the adjacent blocks Bᵢⱼ are extracted from the SAD parameter SAD_{BM}. Motion parameters MVᵢⱼ of the adjacent blocks Bᵢⱼ and a motion parameter MV_{C} of the target blocks B_{C} are extracted from the first motion vector MV_{BM}.

As shown in FIG. 7, the AI weight calculator 146 calculate motion vector differences MVDᵢⱼ of adjacent blocks Bᵢⱼ in the reference window RW relative to the motion vector MV_{C} of the target block B_{C}, according to the first motion vector MV_{BM.} The motion vector differences MVDᵢⱼ include a motion vector differences MVD₀₀ (MV₀₀−MV_{C}), a motion vector differences MVD₀₁ (MV₀₁−MV_{C}), . . . a motion vector differences MVD₄₄ (MV₄₄−MV_{C}).

The AI weight calculator 146 converts the SAD parameters SADij of the adjacent blocks Bᵢⱼ based on a first mapping curve CRV1 into SAD gain values SADGᵢⱼ of the adjacent blocks Bᵢⱼ. For the SAD parameters SADij lower than a first threshold TH1, the SAD gain values SADGᵢⱼ is mapped to “0” according to the first mapping curve CRV1. For the SAD parameters SADij higher than a second threshold TH2, the SAD gain values SADGᵢⱼ is mapped to a maximal gain value G_{MAX} according to the first mapping curve CRV1. For the SAD parameters SADij between the first threshold TH1 and the second threshold TH2, the SAD gain values SADGᵢⱼ is mapped linearly according to the first curve CRV1.

The AI weight calculator 146 calculates a sum of products SUM_{MVD_SADG} between the motion vector differences MVDᵢⱼ and the SAD gain values SADGᵢⱼ.

The AI weight calculator 146 converts the sum of products SUM_{MVD_SADG} based on a second mapping curve CRV2 into the AI weight W_{AI} for the target block B_{C}. The AI weight W_{AI} is a variable between 0 and 1. For the sum of products SUM_{MVD_SADG} lower than a third threshold TH3, the AI weight W_{AI} is mapped to “0” according to the second curve CRV2. For the sum of products SUM_{MVD_SADG} higher than a fourth threshold TH4, the AI weight W_{AI} is mapped to “1” according to the second curve CRV2. For the sum of products SUM_{MVD_SADG} between the third threshold TH3 and the fourth threshold TH4, the AI weight W_{AI} is mapped linearly according to the second curve CRV2.

FIG. 7 illustrates a procedure to calculate one AI weight W_{AI} for the target block B_{C} by the AI weight calculator 146. The AI weight calculator 146 is configured to repeat the same procedure to calculate different AI weights W_{AI} for different target blocks over the whole frame, so as to complete the AI weight map MW_{AI}.

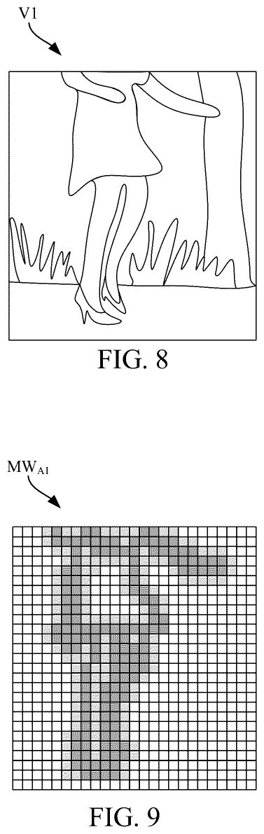

Reference is further made to FIG. 8 and FIG. 9. FIG. 8 is a schematic diagram illustrating an original frame in the first video V1 in some embodiments. FIG. 9 is a schematic diagram illustrating the AI weight map MW_{AI} calculated based on the original frame in the first video V1 shown in FIG. 8.

As shown in FIG. 8, there is a foreground object (e.g., a walking lady wearing a dress) among a background (e.g., a sidewalk with plants) in the first video V1. When the foreground object moves the first video V1, significant SAD values will appears on blocks located at a boundary between a foreground object and a background. The SAD values can highlight areas of motion between frames. If the foreground object moves while the background remains static, the motion estimation process will register significant SAD values in regions where there is a transition from foreground to background.

The SAD parameters SADij will be higher when the target block B_{C} is located adjacent to a boundary between a foreground object (e.g., the lady) and a background in the first video V1. Since the SAD parameters SADij will be higher, the AI weight W_{AI} on this target block B_{C} is higher correspondingly.

On the other hand, the SAD parameters SADij will be lower when the target block B_{C} is located away from a boundary between the foreground object (e.g., the lady) and the background. Since the SAD parameters SADij will be lower, the AI weight W_{AI} on this target block B_{C} is lower correspondingly.

As shown in FIG. 9, the AI weight map MW_{AI} includes some darker blocks (i.e., the AI weight W_{AI} is higher) located around the boundary between the foreground object and the background, and the AI weight map MW_{AI} also includes some brighter blocks (i.e., the AI weight W_{AI} is lower) located away from the boundary between the foreground object and the background.

As shown in FIG. 2, the merger 148c of the integrated motion compensator 148 is able to merge the first interpolated frame F_{iBM} (generated based on block-matching-based ME) and the second interpolated frame F_{iAI} (generated based on AI-based ME) according to the AI weight map MW_{AI}, for generating an output interpolated frame Fᵢ₁.

An output interpolated pixel P(x,y) of the output interpolated frame Fᵢ₁ is determined by:

P(x,y)=P_{iAI}(x,y)*W_{AI}(x,y)+P_{iBM}(x,y)*(1−WAI(x,y))

In aforesaid equation, P_{iBM}(x,y) is a corresponding pixel value from the first interpolated frame F_{iBM}; P_{iAI}(x,y) is a corresponding pixel value from the second interpolated frame F_{iAI}; W_{AI}(x,y) is a corresponding AI weight from the AI weight map MW_{AI}.

Based on aforesaid embodiments, when the output interpolated pixel P(x,y) of the output interpolated frame Fᵢ₁ is closer to the boundary between the foreground object and the background, the AI weight W_{AI}(x,y) on the corresponding target block is higher, a corresponding pixel P(x,y) in the output interpolated frame is determined according to the second interpolated frame F_{iAI} more than the first interpolated frame F_{iBM}. In this case, the second interpolated frame F_{iAI} (generated based on AI-based ME) will contribute more or dominate the value of the output interpolated pixel P(x,y).

On the other hand, when the output interpolated pixel P(x,y) of the output interpolated frame Fᵢ₁ is away from the boundary between the foreground object and the background, the AI weight W_{AI}(x,y) on the corresponding target block is lower, a corresponding pixel P(x,y) in the output interpolated frame is determined according to the first interpolated frame F_{iBM} more than the second interpolated frame F_{iAI}. In this case, the first interpolated frame F_{iBM} (generated based on block-matching-based ME) will contribute more or dominate the value of the output interpolated pixel P(x,y).

As shown in FIG. 2, the output interpolated frame Fᵢ₁ can be inserted between the previous frame F₀ and the current frame F₁ for generating the second video V2. Similarly, another output interpolated frame Fᵢ₂ can be generated and inserted between the frames F₁ and F₂. In other word, at least one output interpolated frame can be generated between two adjacent frames in the first video V1. As shown in FIG. 1, the processor 140 is configured to generate the second video V2 according original frames F₀, F₁ and F₂ and the interpolated frames Fᵢ₁ and Fᵢ₂.

The second video V2 has a higher frame rate than the first video V1. As shown in FIG. 1, the second video V2 generated by the processor 140 can be displayed on the displayer 160. In this case, the displayer 160 can display the second video V2 with a higher frame rate than the original video (i.e., the first video V1) provided by the video source 120.

This disclosure provides a way to integrate the block-matching-based motion estimation and the AI-based motion estimation. It can enhance an interpolation quality, particularly in boundary areas. The AI-based motion estimation is able to solve issues such as data-broken and halo problems associated with block-matching-based ME. It can offer smoother transitions near occlusion areas, resulting in more natural occlusion effects and motion flow transitions.

This disclosure can combine the advantages of AI-based motion estimation and block-matching-based motion estimation. This disclosure can resolve broken and halo issues that the block-matching-based ME struggles with in intermingled foreground and background scenarios, by applying the AI-based motion estimation to these areas. By integrating the block-matching-based motion estimation, the block-matching-based motion estimation can provide expected results and can be fine-tuned efficiently (without complex training).

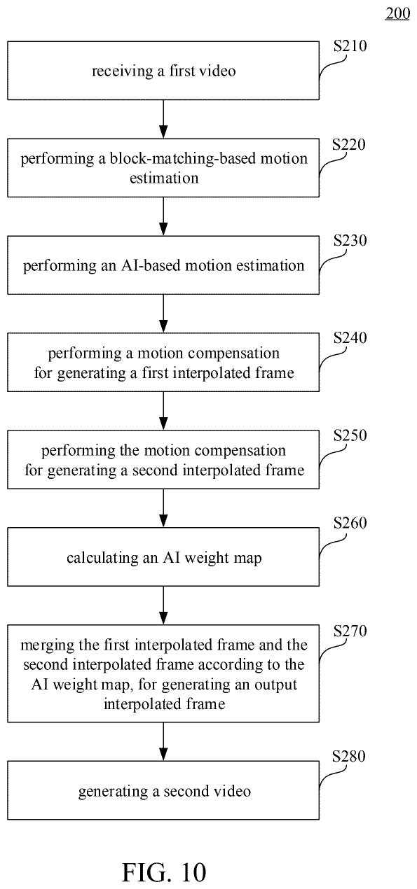

In the embodiments, the disclosure also provides an image processing method executed by the processor 140. Reference is further made to FIG. 10, which is a flowchart diagram illustrating the image processing method 200 in some embodiments of the disclosure.

The image processing method 200 includes following steps S210 to S280. In step S210, the processor 140 receives a first video V1 includes a previous frame F₀ and a current frame F₁ from the video source 120.

In step S220, the processor 140 performs a block-matching-based motion estimation, between the previous frame F₀ and the current frame F₁, for generating the first motion vector MV_{BM}, the first occlusion parameter OC_{BM}, and the sum of absolute differences (SAD) parameter SAD_{BM}. In step S230, the processor 140 performs an AI-based motion estimation, between the previous frame F₀ and the current frame, for generating the second motion vector MV_{AI} and the second occlusion parameter OC_{AI}. In step S240, the processor 140 performs a motion compensation according to the first motion vector MV_{BM}, the first occlusion parameter OC_{BM}, the previous frame F₀ and the current frame F₁, for generating the first interpolated frame F_{iBM}. In step S250, the processor 140 performs another motion compensation according to the second motion vector MV_{AI}, the second occlusion parameter OC_{AI}, the previous frame F₀ and the current frame F₁, for generating the second interpolated frame F_{iAI}.

In step S260, the processor 140 calculates an AI weight map MW_{AI} according to the first motion vector MV_{BM} and the SAD parameter SAD_{BM}. In step S270, the processor 140 merges the first interpolated frame F_{iBM} and the second interpolated frame F_{iAI} according to the AI weight map MW_{AI}, for generating the output interpolated frame Fᵢ₁. In step S280, the processor 140 generate the second video V2 according to the previous frame F₀, the output interpolated frame Fᵢ₁ and the current frame F₁. More details about steps S210 to S280 have been discussed in aforesaid embodiments, and not repeated again.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electronic device, comprising:
a video source, configured to provide a first video comprising a previous frame and a current frame;
a processor, coupled to the video source, wherein the processor is configured to:
perform a block-matching-based motion estimation, between the previous frame and the current frame, for generating a first motion vector, a first occlusion parameter and a sum of absolute differences (SAD) parameter;
perform an AI-based motion estimation, between the previous frame and the current frame, for generating a second motion vector and a second occlusion parameter;
perform a motion compensation according to the first motion vector, the first occlusion parameter, the previous frame and the current frame, for generating a first interpolated frame;
perform another motion compensation according to the second motion vector, the second occlusion parameter, the previous frame and the current frame, for generating a second interpolated frame;
calculate an AI weight map according to the first motion vector and the SAD parameter; and
merge the first interpolated frame and the second interpolated frame according to the AI weight map, for generating an output interpolated frame.

2. The electronic device of claim 1, wherein the processor is further configured to:
generate a second video (V2) according to the previous frame, the output interpolated frame and the current frame,
wherein a frame rate of the second video is higher than a frame rate of the first video.

3. The electronic device of claim 1, wherein the processor is further configured to execute an AI motion estimation model for performing the AI-based motion estimation, the AI motion estimation model is trained together with an AI motion compensation model according to training input frames and a training ground interpolated frame.

4. The electronic device of claim 3, wherein during a training procedure of the AI motion estimation model and the AI motion compensation model, the AI motion estimation model is configured to generate an intermediate output data according to the training input frames, the AI motion compensation model is configured to generate a prediction interpolated frame according to the intermediate output data, the prediction interpolated frame is compared with the training ground interpolated frame for a backpropagation for optimizing the AI motion estimation model and the AI motion compensation model,
the intermediate output data comprises a prediction motion vector and a prediction occlusion parameter corresponding to the training input frames.

5. The electronic device of claim 1, wherein the AI weight map is calculated by:
determining a reference window around a target block;
calculating motion vector differences of adjacent blocks in the reference window relative to the target block according to the first motion vector;
generating SAD gain values of the adjacent blocks in the reference window according to the SAD parameter; and
calculating an AI weight on the target block according to a sum of products between the motion vector differences and the SAD gain values.

6. The electronic device of claim 5, wherein the AI weight on the target block is higher when the target block is located adjacent to a boundary between a foreground object and a background.

7. The electronic device of claim 6, wherein, in response to that the AI weight on the target block is higher, a corresponding pixel in the output interpolated frame is determined according to the second interpolated frame more than the first interpolated frame.

8. The electronic device of claim 6, wherein, in response to that the AI weight on the target block is lower, a corresponding pixel in the output interpolated frame is determined according to the first interpolated frame more than the second interpolated frame.

9. The electronic device of claim 1, wherein the first occlusion parameter is configured to determine weights of the previous frame and the current frame while generating the first interpolated frame,
the second occlusion parameter is configured to determine weights of the previous frame and the current frame while generating the second interpolated frame.

10. An image processing method, comprising:
receiving a first video comprising a previous frame and a current frame;
performing a block-matching-based motion estimation, between the previous frame and the current frame, for generating a first motion vector, a first occlusion parameter, and a sum of absolute differences (SAD) parameter;
performing an AI-based motion estimation, between the previous frame and the current frame, for generating a second motion vector and a second occlusion parameter;
performing a motion compensation according to the first motion vector, the first occlusion parameter, the previous frame and the current frame, for generating a first interpolated frame;
performing another motion compensation according to the second motion vector, the second occlusion parameter, the previous frame and the current frame, for generating a second interpolated frame;
calculating an AI weight map according to the first motion vector and the SAD parameter; and
merging the first interpolated frame and the second interpolated frame according to the AI weight map, for generating an output interpolated frame.

11. The image processing method of claim 10, further comprising:
generating a second video according to the previous frame, the output interpolated frame and the current frame,
wherein a frame rate of the second video is higher than a frame rate of the first video.

12. The image processing method of claim 10, wherein the AI-based motion estimation is performed by an AI motion estimation model, wherein the AI motion estimation model is trained together with an AI motion compensation model according to training input frames and a training ground interpolated frame.

13. The image processing method of claim 12, wherein during a training procedure of the AI motion estimation model and the AI motion compensation model, the AI motion estimation model is configured to generate an intermediate output data according to the training input frames, the AI motion compensation model is configured to generate a prediction interpolated frame according to the intermediate output data, the prediction interpolated frame is compared with the training ground interpolated frame for a backpropagation for optimizing the AI motion estimation model and the AI motion compensation model,
the intermediate output data comprises a third motion vector and a third occlusion parameter corresponding to the training input frames.

14. The image processing method of claim 10, wherein step of calculating the AI weight map comprises:
determining a reference window around a target block in the AI weight map;
calculating motion vector differences of adjacent blocks in the reference window relative to the target block according to the first motion vector;
calculating SAD gain values of the adjacent blocks in the reference window according to the SAD parameter; and
calculating an AI weight on the target block according to a sum of products between the motion vector differences and the SAD gain values.

15. The image processing method of claim 14, wherein the AI weight on the target block is higher when the target block is located adjacent to a boundary between a foreground object and a background.

16. The image processing method of claim 15, wherein, in response to that the AI weight on the target block is higher, a corresponding pixel in the output interpolated frame is determined according to the second interpolated frame more than the first interpolated frame.

17. The image processing method of claim 15, wherein, in response to that the AI weight on the target block is lower, a corresponding pixel in the output interpolated frame is determined according to the first interpolated frame more than the second interpolated frame.

18. The image processing method of claim 10, wherein the first occlusion parameter is configured to determine weights of the previous frame and the current frame while generating the first interpolated frame,
the second occlusion parameter is configured to determine weights of the previous frame and the current frame while generating the second interpolated frame.
